(19) United States
(12) Patent Application Publication
(10) Pub. No.: US 2005/0195174 A1
(43) Pub. Date: Sep. 8, 2005

(54) Electronic device with touching unit

(75) Inventor: Ming Yuan Ho, Sindian City (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 10/963,735

(22) Filed: Oct. 14, 2004

(30) Foreign Application Priority Data
Mar. 5, 2004 (TW) 093105994

(51) Int. Cl. G09G 5/00

(52) U.S. Cl. 345/173

(57) ABSTRACT

An electronic device includes a shell, a detecting unit and a touching unit. In this case, the shell has at least one opening. The detecting unit is disposed in the shell and below the opening. The touching unit has a first portion and a second portion. The touching unit covers the opening. The first portion faces to the detecting unit. The second portion is disposed around the first portion and is connected to the shell.

### BACKGROUND OF THE INVENTION

1. Field of Invention

The invention relates to an electronic device and, in particular, to an electronic device comprising a touching unit made by plastic lamina, whereby the height difference between the touching unit and the shell of the computer main body can be reduced.

2. Related Art

As technology improves, many devices for generating control signals have been invented in recent years in the field of portable electronic products, so that the cursor can be moved on the display screen according to the control signals. These devices, for example, include mice, track balls, joysticks, touch pads, track points, and etc.

Among those devices, the touch pad is an invention that brings a lot of convenience. It not only allows the user to control the cursor on the screen by moving his/her finger thereon in coordination with clicking the touching pad buttons, but also possesses a function similar to that of the left and right buttons of a mouse.

As shown in FIG. 1, a touch pad 12 is provided on the shell 11 of the main body of a conventional electronic device 1, such as a computer. A touch pad frame 13, which is made of metal, is adhered to the periphery of the touch pad 12. The metal touching pad frame would not be placed on the touch pad 12 in order to avoid interfering the sensitivity of the touch pad 12.

Referring to FIG. 2, since the touch pad frame 13 can only be disposed around the periphery of the touch pad 12, an obvious height difference d1 is produced between the touch pad 12 and the touch pad frame 13, which is adhered to the main body 11. Accordingly, the height difference d1 between the touch pad frame 13 and touch pad 12 will increase as the thickness of the metal touch pad frame 13 increases. As a result, dust may accumulate in the gap between the touch pad frame 13 and touch pad 12, and moreover, the beauty of the design for the electronic device 1 may be affected due to lack of integrity.

In view of the aforementioned problems, it is a subjective of the invention to provide an electronic device, which can eliminate the obvious height difference between the touch pad frame and the touch pad, and the dust accumulation.

### SUMMARY OF THE INVENTION

In view of the foregoing, the present invention is to provide an electronic device, which comprises a touching unit made by plastic lamina for reducing the height difference between the touching unit and the shell of the computer main body.

To achieve the above, an electronic device of the present invention includes a shell, a detecting unit and a touching unit. In the invention, the shell has at least one opening. The detecting unit is disposed in the shell and below the opening. The touching unit has a first portion and a second portion, and covers the opening. The first portion faces to the detecting unit, and the second portion is disposed around the periphery of the first portion and is connected to the shell.

As mentioned above, the electronic device of the invention comprises a touching unit, which is integrally formed by stamping plastic materials. The thickness of the touching unit is very thin, and, therefore, the height difference between the touching unit and the shell of the computer main body can be reduced. Compared to the prior art, the height difference between the touching unit and the shell of the main body of the electronic device of the present invention is reduced, and the design of the present invention shows better integrity. In addition, since the touching unit is connected to the computer main body and faces to the detecting unit, the height difference is reduced and the dust accumulation between the touching pad frame and the touching pad as described in the prior art would not occur. Further, the touching unit produced by the stamping process is thinner and the cost of the stamping process is cheaper, so that the production cost can be reduced.

### BRIEF DESCRIPTION OF THE DRAWINGS

The invention will become more fully understood from the detailed description given hereinbelow illustration only, and thus is not limitative of the present invention, and wherein:

FIG. 1 is a schematic diagram illustrating the conventional electronic device;

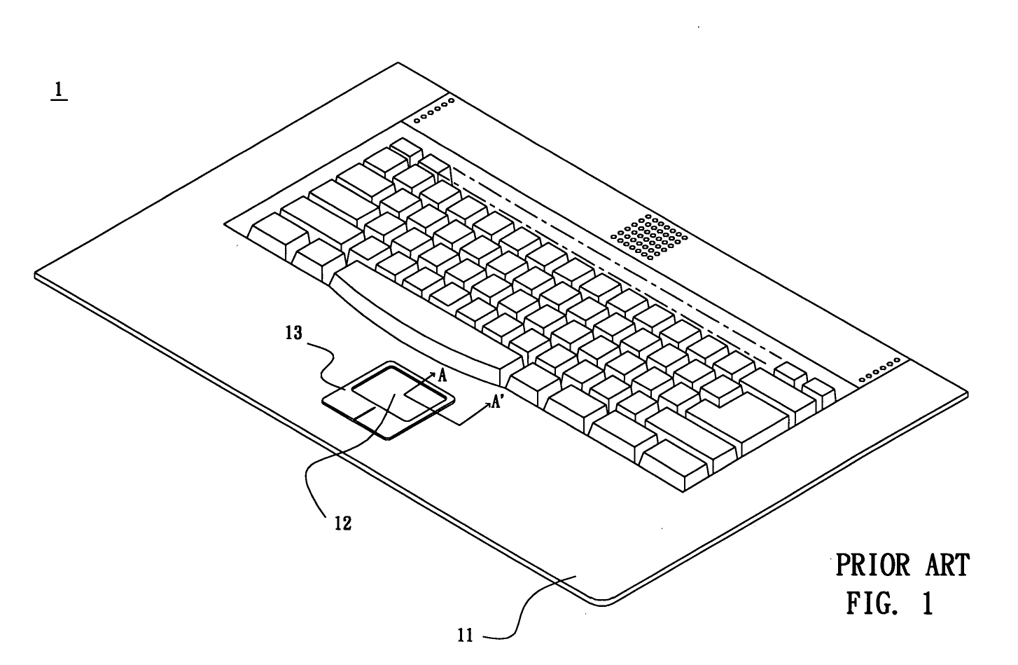

FIG. 2 is a cross-sectional view of the conventional electronic device taken along the line A-A′ shown in FIG. 1;

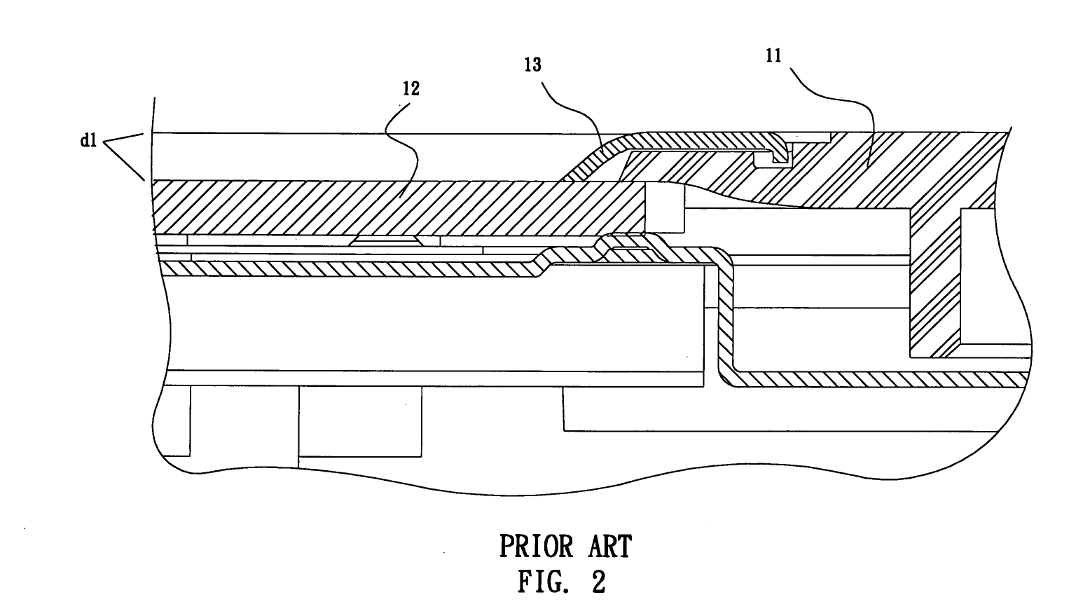

FIG. 3 is a schematic diagram illustrating an electronic device according to a preferred embodiment of the invention; and

FIG. 4 is a cross-sectional view of the electronic device according to the embodiment of the invention taken along the line B-B′ shown in FIG. 3.

### DETAILED DESCRIPTION OF THE INVENTION

The present invention will be apparent from the following detailed description, which proceeds with reference to the accompanying drawings, wherein the same references relate to the same elements.

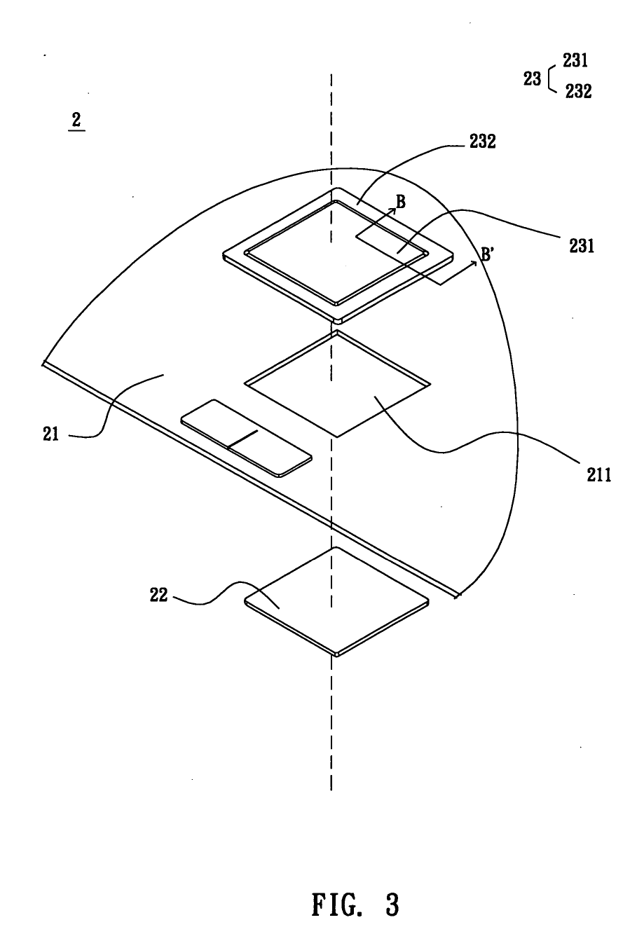

As shown in FIG. 3, the electronic device 2 according to a preferred embodiment of the invention comprises a shell 21, a detecting unit 22 and a touching unit 23.

The shell 21 is a shell of a portable data processor, such as a shell of a notebook computer main body. The shell 21 has at least one opening 211.

The detecting unit 22 is disposed in the shell and below the opening 211. The detecting unit 22 is a touch pad, and plural sensing circuits are distributed on the surface thereof. When an object (for example, a finger or a stylus pen) moves on the touch pad, a signal for controlling the movement of a cursor is produced due to a change in the capacitance or the resistance of the sensing circuit.

The touching unit 23 has a first portion 231 (the gray part) and a second portion 232, and the touching unit 23 covers the opening 211. The touching unit 23 is made by polycarbonate (PC) or polyethylene terephthalate (PET), and a thin touching unit 23 can be formed by using the stamping process. In the present embodiment, the touching unit 23 has a thickness less than 0.6 mm.

As shown in FIG. 3, the first portion 231 of the touching unit 23 faces to the detecting unit 22. The second portion 232 is disposed around the first portion 231 and is connected to the shell. Further, the second portion 232 is adhered to the shell 21 by using an adhesive or a twin adhesive. Moreover, the first portion 231 and second portion 232 is integrally formed by a stamping process. In addition, since the first portion 231 and second portion 232 is integrally formed, it can protect the sensitivity of the detecting unit from the interference of dust.

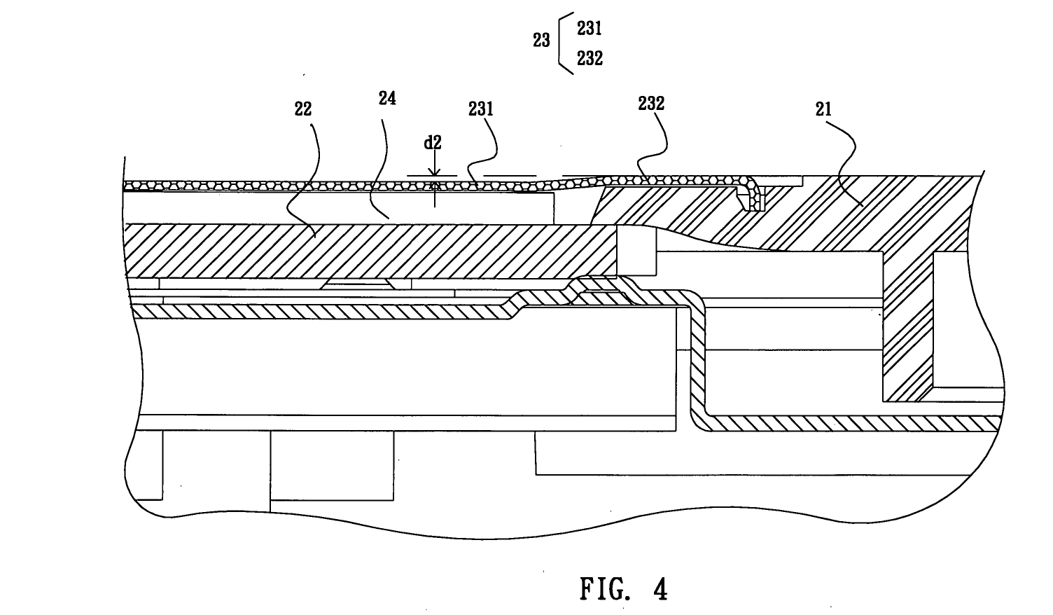

As shown in FIG. 4, the electronic device 2 according to the embodiment of the invention further comprises a spacer 24, which is provided between the detecting unit 22 and the touching unit 23, so as to maintain a distance therebetween. The thickness of the touching unit 23, which is formed by stamping plastic materials, is very thin, and thus, due to the weak mechanical strength, the touch pad may bend when the user presses a great strength thereon. Accordingly, the sensitivity thereof may decrease. Such being the circumstance, the spacer 24 is used to strengthen the mechanical strength of the touching unit 23.

In addition, as shown in FIG. 4, the height difference between the first portion 231 and the second portion 232 of the touching unit 23 is not conspicuous, and to view as a whole, there is only a small height difference d2 remain. Therefore, the design of the electronic device 2 shows better integrity.

In summary, the electronic device of the present invention includes a touching unit that is integrally formed by stamping the plastic materials, and the thickness thereof is quite thin that the height difference between the touching unit and the shell of the computer main body can be reduced. Compared to the prior art, the height difference between the touching unit and the shell of the computer main body is smaller in the electronic device of the present invention, and the design of the electronic device of the present invention shows better integrity. In addition, since the touching unit is connected to the computer main body and faces to the detecting unit, the height difference is reduced and dust accumulations between the touch pad frame and the touch pad as described in the prior art would not occur. Furthermore, the touching unit produced by the stamping process is thinner and the cost of the stamping process is cheaper, so that the production cost is reduced.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

1. An electronic device, comprising:
a shell having at least one opening;
a detecting unit disposed in the shell and below the opening; and
a touching unit having a first portion and a second portion, the touching unit covering the opening, the first portion facing to the detecting unit, and the second portion being disposed around the first portion and being connected to the shell.

2. The electronic device according to claim 1, wherein said detecting unit is a touch pad.

3. The electronic device according to claim 2, wherein plural sensing circuits are distributed on the surface of the detecting unit, and when an object moves on the touching pad, the capacitances or the resistances of the sensing circuits are changed so as to generate a signal.

4. The electronic device according to claim 1, further comprising:
a spacer disposed between the detecting unit and the touching unit.

5. The electronic device according to claim 1, wherein the touching unit is formed by a stamping process.

6. The electronic device according to claim 1, wherein the first portion and the second portion are integrally formed.

7. The electronic device according to claim 1, wherein the second portion is connected to the shell with an adhesive.

8. The electronic device according to claim 1, wherein the material of the touching unit is polycarbonate (PC) or polyethylene terephthalate (PET).

9. The electronic device according to claim 1, wherein the thickness of the touching unit is less than 0.6 mm.
